(19) United States
(12) Patent Application Publication
(10) Pub. No.: US 2013/0179118 A1
(43) Pub. Date: Jul. 11, 2013

(54) System And Method For Inspecting A Blade Component

(71) Applicants: Rachel Marie Suffield, Greenville, SC (US); Waseem Ibrahim Faidi, Schenectady, NY (US); Christopher Allen Nafis, Rexford, NY (US)

(72) Inventors: Rachel Marie Suffield, Greenville, SC (US); Waseem Ibrahim Faidi, Schenectady, NY (US); Christopher Allen Nafis, Rexford, NY (US)

(73) Assignee: GENERAL ELECTRIC COMPANY, Schenectady, NY (US)

(21) Appl. No.: 13/345,056

(22) Filed: Jan. 6, 2012

(51) Int. Cl. G06F 15/00

(52) U.S. Cl. 702/155

(57) ABSTRACT

A system for inspecting a blade component is provided, and includes a blade component having an outer surface, a rail, a cart, at least one optical metrology device, and a computing device. The cart is moveable in at least one direction along the rail. The cart includes a composite material that is laid on a mold to build the blade component. The optical metrology device is connected to the cart. The optical metrology device monitors application of the composite material to the outer surface of the blade component. The optical metrology device creates a set of measurements based on the outer surface of the blade component where the composite material is applied. The computing device is in communication with the optical metrology device and receives the set of measurements.

### BACKGROUND OF THE INVENTION

The subject matter disclosed herein relates to a system for inspecting a blade component, and more specifically to a system for inspecting a blade component that determines if a defect is present along an outer surface of the blade component where a composite material is applied.

Generally, a wind turbine includes a rotor having multiple blades. The rotor is mounted on a housing, or nacelle, that is positioned on top of a truss or tubular tower. The blades may each include two shell portions and a spar web located between the two shell portions. Spar caps are placed at opposing sides of the spar web. The spar caps provide structural reinforcement of the blade. In one approach, the spar cap may be fabricated by using prepreg materials. The prepreg composites material is generally a layer of fibrous composite material that is impregnated with a polymer resin.

The prepreg material may be applied using a manual or hand lay-up, or by automated or semi-automated methods, such as a cart that moves along a set of tracks. However, when applying the prepreg material, sometimes defects such as, for example, out of plane wrinkles, gaps, fuzz, fiber misalignment, and foreign objects caught in the prepreg material may occur. The current approach to detect defects involves relying on a visual inspection of the prepreg material during lay-up. In the event a defect is detected after the spar cap has cured, non-destructive evaluation (“NDE”) methods may be used, which results in repair and rework.

### BRIEF DESCRIPTION OF THE INVENTION

According to one aspect of the invention, a system for inspecting a blade component is provided, and includes a blade component having an outer surface, a rail, a cart, at least one optical metrology device, and a computing device. The cart is moveable in at least one direction along the rail. The cart includes a composite material that laid on a mold to build the blade component. The optical metrology device is connected to the cart. The optical metrology device monitors application of the composite material to the outer surface of the blade component. The optical metrology device creates a set of measurements based on the outer surface of the blade component where the composite material is applied. The computing device is in communication with the optical metrology device and receives the set of measurements. The computing device includes control logic for determining if the set of measurements indicate a defect is present along the outer surface of the blade component where the composite material is applied.

According to another aspect of the invention, an inspection method for a blade component is provided. The method includes providing a cart that is moveable in at least one direction along a rail. The method also includes building the blade component with a composite material that is laid on a mold as the cart moves in the at least one direction. The method also includes monitoring application of the composite material to the blade component by at least one optical metrology device. The optical metrology device performs a set of measurements of an outer surface of the blade component where the reinforcement material is applied. The optical metrology device is connected to the cart such that the at least one optical metrology device moves in the at least one direction along with the cart. The method includes determining if the set of measurements indicate a defect is present along the outer surface of the blade component where the composite material is applied.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an inspection system for a blade component; and

FIG. 2 is a process flow diagram illustrating one approach of operating the inspection system shown in FIG. 1.

The detailed description explains embodiments of the invention, together with advantages and features, by way of example with reference to the drawings.

### DETAILED DESCRIPTION OF THE INVENTION

As used herein the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

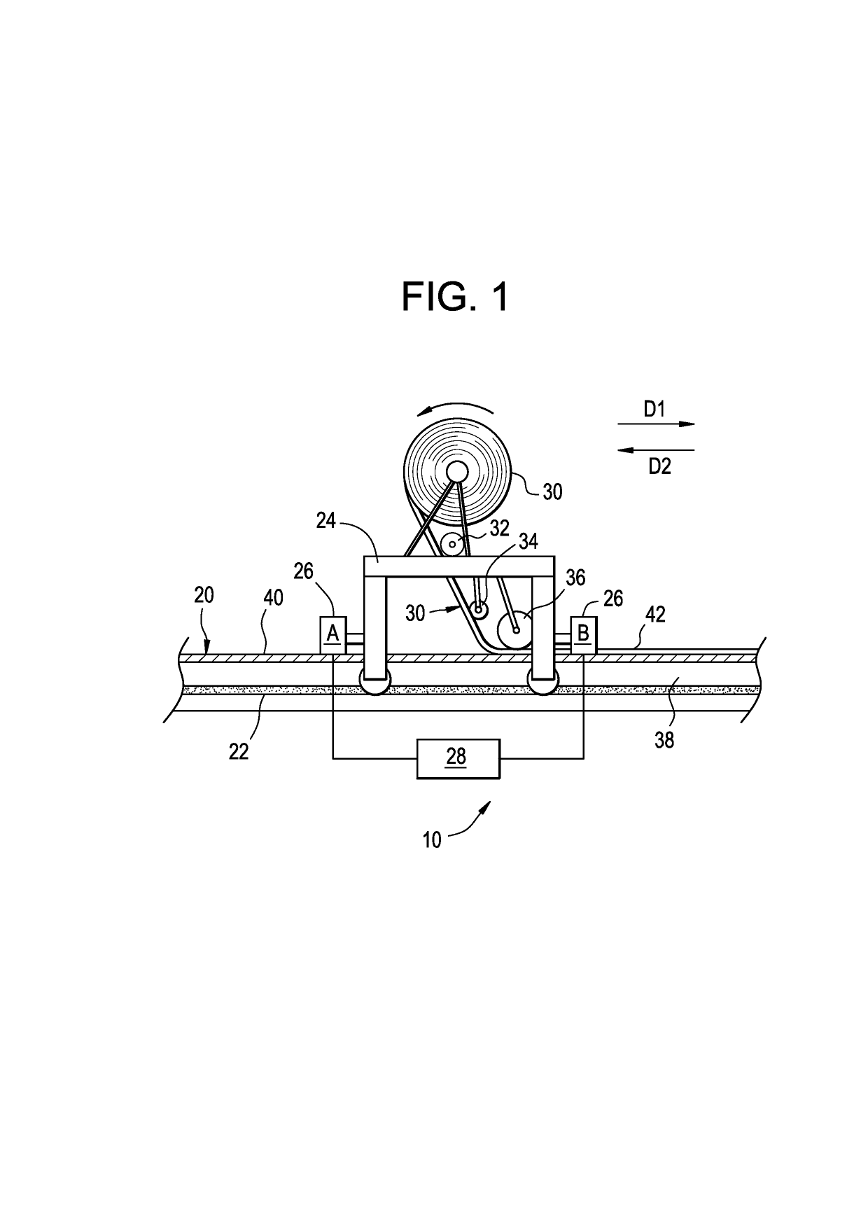

Referring now to FIG. 1, an exemplary inspection system 10 for a blade component 20 is illustrated. The inspection system 10 includes a rail 22, a moveable cart 24, at least one optical metrology device 26, and a computing device 28. The cart 24 includes a reinforcement material 30, a first guide 32, a second guide 34, and a compaction roller 36. The cart 24 is moveable along the rail 22 in generally opposing directions D1 and D2. The blade component 20 may be, for example, a spar, a spar cap, or an airfoil skin of a wind turbine blade. The blade component 20 located or placed in a mold or frame 38.

In the exemplary embodiment as shown in FIG. 1, the composite material 30 is provided in a roll form, and may be applied to an outer surface 40 of the blade component 20. The composite material 30 may be, for example, a prepreg or any other type of composite material. The composite material 30 may further include a polymer backing material 42 as well. The composite material 30 is laid down on the mold 38 to build the blade component 20 as the cart 24 travels along the rail 22 in directions D1 and D2, where the compaction roller 36 may be used to further compact or compress the composite material 30 against the blade component 20.

In the embodiment as shown in FIG. 1, two optical metrology devices 26 are used, where the optical metrology device labeled ‘A’ is employed as the cart 24 moves in the direction D1 and the optical metrology device labeled ‘B’ is employed as the cart 24 moves in the direction D2. The optical metrology devices 26 are connected to and move with the cart 24. Both the optical metrology devices 26 are in communication with the computing device 28. The computing device 28 is any type of processing device such as, for example, a controller or a computer. In one embodiment, the optical metrology devices 26 are in communication with the computing device 28 by a wired connection, however a wireless data link connection may be used as well.

The optical metrology device 26 monitors application of the composite material 30 and generates a set of measurements of the outer surface of the blade component 20 where the composite material 30 has been applied. In one exemplary embodiment, the optical metrology device 26 includes a camera (not shown), a laser source (not shown), and a white light source (not shown) such as, for example, an LED light. The optical metrology device 26 obtains the set of measurements based on the outer surface 40 of the blade components 20 where the composite material 30 has been applied. The optical metrology device 26 sends the set of measurements to the computing device 28.

In one approach, the set of measurements from the optical metrology device 26 includes three dimensional or optical metrology data. The computing device 28 includes control logic for calculating three dimensional measurements based on the three dimensional data obtained from the optical metrology device 26. The three dimensional measurements represent the dimensions of the outer surface 40 of the blade component 20 where the composite material 30 has been applied prior to the composite material 30 curing.

The computing device 28 further includes a memory that stores a three dimensional data model. Specifically, the three dimensional data model includes three dimensional data points that indicate a three dimensional defect along the outer surface 40 of the blade component 20 after the composite material 30 has cured. The three dimensional defect is also referred to as an out of plane defect. Some examples of three dimensional defects include, for example, wrinkles, and overlaps in the composite material 30. The computing device 28 includes control logic for comparing the three dimensional measurements prior to the composite material 30 curing with the three dimensional data points that indicate the three dimensional defect after the composite material 30 has cured. The computing device 28 further includes control logic for determining if the three dimensional measurements will result in the three dimensional defect in the reinforcement material 30 after the composite material 30 has had a chance to cure based on the three dimensional data points. The computing device 28 may also include control logic to distinguish an actual defect from nominal part geometry variations that may occur in the blade component 20.

In another approach, the set of measurements from the optical metrology device 26 includes two dimensional data. The computing device 28 includes control logic for calculating two dimensional measurements based on the two dimensional data obtained from the optical metrology device 26. The two dimensional measurements of the outer surface 40 represent the dimensions prior to the composite material 30 curing.

The memory of the computing device 28 stores a two dimensional data model. The two dimensional data model is used to detect a two dimensional defect along the outer surface 40 of the blade component 20 where the composite material 30 has been applied. The two dimensional defect is also referred to as an in plane defect. Some examples of two dimensional defects include, for example, fiber misalignment, fuzz, gaps, or fiber breakage in the composite material 30. The computing device 28 includes control logic for comparing the two dimensional measurements prior to the composite material 30 curing with the two dimensional data points that indicate the two dimensional defect after the composite material 30 has cured. The computing device 28 further includes control logic for determining if the two dimensional measurements will result in the two dimensional defect in the composite material 30 after the composite material 30 has had a chance to cure based on the two dimensional data points.

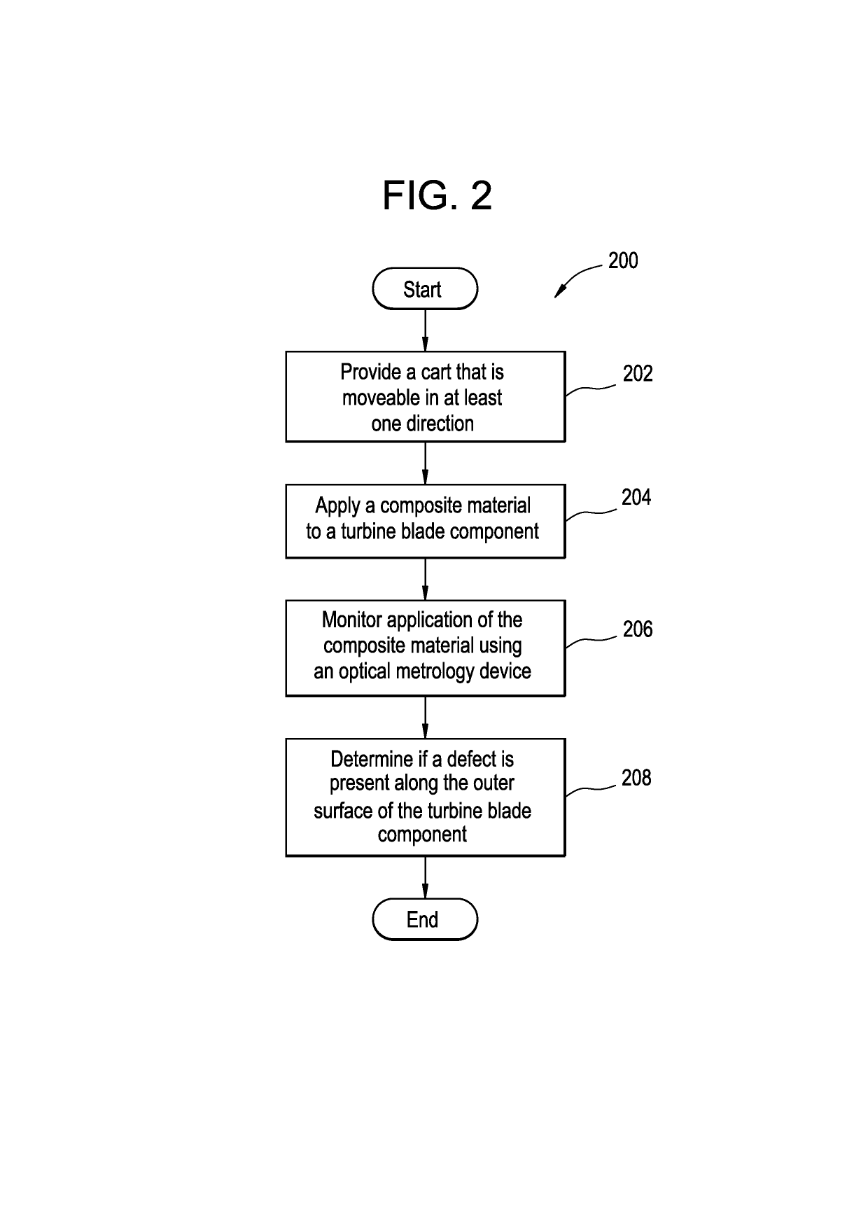

A method of operating the inspection system 10 will now be discussed. FIG. 2 is a process flow diagram illustrating a method of detecting a defect on the outer surface 40 of the blade component 20 after the composite material 30 has been applied. Process 200 begins at 202, where a cart 24 that is moveable in at least one direction along a rail 22 is provided. Referring to FIG. 1, in one embodiment the cart 24 is moveable along the rail 22 in generally opposing directions D1 and D2. The cart 24 includes a composite material 30 such as, for example, a prepreg material. Process 200 may then proceed to 204.

In 204, the composite material 30 is laid on to a mold 38 to build the blade component 20. Process 200 may then proceed to 206.

In 206, the application of the composite material 30 is monitored by an optical metrology device 26. The optical metrology device 26 generates a set of measurements based on the outer surface 40 of the blade component 20 where the composite material 30 has been applied. Process 200 may then proceed to 208.

In 208, the computing device 28 includes control logic for determining if a defect is present. Specifically, the computing device 28 includes control logic for for determining if the set of measurements indicate a defect is present along the outer surface 40 of the blade component 20 where the composite material 30 is applied. Process 200 may then terminate.

The inspection system 10 for the blade component 20 as described in FIGS. 1-2 will result in the detection of defects located within the composite material 30 prior to curing. Finding defects in the composite material 30 prior to curing will allow for isolation and removal of the defect, which in turn leads to material savings as well as increased efficiency.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for inspecting a blade component, comprising:
a blade component having an outer surface;
a rail;
a cart moveable in at least one direction along the rail, the cart including a composite material that is laid on a mold to build the blade component;
at least one optical metrology device that is connected to the cart, the at least one optical metrology device monitoring application of the composite material to the outer surface of the blade component, the at least one optical metrology device creating a set of measurements based on the outer surface of the blade component where the composite material is applied; and
a computing device in communication with the at least one optical metrology device and receiving the set of measurements, the computing device including control logic for determining if the set of measurements indicate a defect is present along the outer surface of the blade component where the composite material is applied.

2. The system of claim 1, wherein the blade component is one of a spar, a spar cap, and an airfoil skin of a wind turbine.

3. The system of claim 1, wherein the composite material is a prepreg material.

4. The system of claim 1, wherein the cart is moveable in two generally opposing directions, and wherein another optical metrology device is provided.

5. The system of claim 4, wherein the at least one optical metrology device monitors application of the composite material as the cart moves in one of the two generally opposing directions, and the another optical metrology device monitors application of the composite material as the cart moves in the other of the two generally opposing directions.

6. The system of claim 1, wherein the set of measurements from the at least one optical metrology device includes three dimensional data, and wherein the computing device includes control logic for calculating a set of three dimensional measurements based on the three dimensional data.

7. The system of claim 6, wherein the computing device includes control logic for determining if the set of three dimensional measurements will result in a three dimensional defect in the composite material after the composite material has cured.

8. The system of claim 1, wherein the set of measurements from the at least one optical metrology device includes two dimensional data, and wherein the computing device includes control logic for calculating a set of two dimensional measurements based on the two dimensional data.

9. The system of claim 8, wherein the computing device includes control logic for determining if the set of two dimensional measurements will result in a two dimensional defect in the composite material after the composite material has cured.

10. The system of claim 1, wherein the defect is one of an out of plane defect and an in plane defect.

11. An inspection method for a blade component, comprising:
providing a cart that is moveable in at least one direction along a rail;
building a blade component with a composite material that is laid on a mold as the cart moves in the at least one direction;
monitoring application of the composite material to the blade component by at least one optical metrology device, the at least one optical metrology device performing a set of measurements of an outer surface of the blade component where the composite material is applied, the at least one optical metrology device connected to the cart such that the at least one optical metrology device moves in the at least one direction along with the cart; and
determining if the set of measurements indicate a defect is present along the outer surface of the blade component where the composite material is applied by a computing device.

12. The method of claim 11, comprising providing the blade component that is one of a spar, a spar cap, and an airfoil skin of a wind turbine.

13. The method of claim 11, comprising providing the composite material that is a prepreg material.

14. The method of claim 11, comprising providing the cart that is moveable in two generally opposing directions, and wherein another optical metrology device is provided.

15. The method of claim 14, comprising monitoring application of the composite material by the at least one optical metrology device as the cart moves in one of the two generally opposing directions, and wherein the another optical metrology device monitors application of the composite material as the cart moves in the other of the two generally opposing directions.

16. The method of claim 11, comprising including three dimensional data, wherein the set of measurements from the at least one optical metrology device includes the three dimensional data, and wherein the computing device includes control logic for calculating a set of three dimensional measurements based on the three dimensional data.

17. The method of claim 16, comprising determining if the set of three dimensional measurements will result in a three dimensional defect in the composite material after the composite material has cured.

18. The method of claim 11, comprising including two dimensional data, wherein the set of measurements from the at least one optical metrology device includes the two dimensional data, and wherein the computing device includes control logic for calculating a set of two dimensional measurements based on the two dimensional data.

19. The method of claim 18, comprising determining if the set of two dimensional measurements will result in a two dimensional defect in the composite material after the composite material has cured.

20. The method of claim 11, wherein the defect is one of an out of plane defect and an in plane defect.
